(19) United States
(12) Patent Application Publication
(10) Pub. No.: US 2001/0048187 A1
(43) Pub. Date: Dec. 6, 2001

(54) Automatic door for molten metal holding furnace

(76) Inventor: Andrea Bortoloni, Noventa Padovana (IT)

Correspondence Address: DOWELL & DOWELL PC, SUITE 309, 1215 JEFFERSON DAVIS HIGHWAY, ARLINGTON, VA, 22202

(21) Appl. No.: 09/848,260

(22) Filed: May 4, 2001

(30) Foreign Application Priority Data
May 31, 2000 (IT) PD2000 A000146

(51) Int. Cl. C22B 7/00; F27D 1/18; B23K 1/00; C21B 7/06

(52) U.S. Cl. 266/242; 266/275; 266/287; 432/250

(57) ABSTRACT

The invention is a new automatic door for molten metal holding furnaces, comprising a fixed plate with charging and inspection hole, provided with two supports positioned at the sides of the charging hole and with two vertical wings positioned on the upper part of the plate; two guides with rectangular hole are hinged to the two vertical wings positioned on the upper part of the plate and directed downwards, beyond the lower edge of the charging hole; the closing panel with gasket is equipped with lateral pins that in turn are housed in the rectangular holes of the guides, said pins and guides being suitable for making the closing panel slide along the guides. One or more pressuremechanisms, acting on the lower end of the guides, rotate the guides in such a way as to bring the closing panel in contact with the plate hole and press the panel against the hole or to move it away from the plate. A hydraulic cylinder controls the translation of the closing panel along the guides with rectangular hole.

### DESCRIPTION

The present invention concerns the plants for the production of metal articles through the feeding of molten metal under pressure from the holding furnace to the die positioned on the surface of a press located on the furnace itself.

At present many metal articles, for example the rims of vehicle wheels, are produced through the forced injection of molten metal into a die.

Molten metal is usually kept into holding furnaces; a hydraulic press is positioned on top of the holding furnace and on the lower plane of said press a die is provided, which communicates with the bottom of the holding furnace through a vertical duct; the furnace is pressurized with compressed air, so that the molten metal is conveyed upwards along the duct until reaching the die and filling it.

Molten metal is periodically introduced in the holding furnace through an appropriate opening provided with a door.

Since the furnace is pressurized with compressed air, the door must ensure perfect seal. For this purpose, the door is provided with a gasket made of a suitable heat-resistant material, which, however, wears out due to repeated use and must be periodically replaced.

At present the doors of holding furnaces comprise a simple panel hinged to the furnace, which is lifted either for the introduction of new molten metal into the furnace itself and for the replacement of the gasket.

These doors present a series of drawbacks, since the opening and closing mechanism exerts an asymmetrical pressure on the gasket and does not ensure perfect seal, thus making it necessary to change the gasket frequently; furthermore, due to this opening and closing system maintenance operations on the door and/or on the charging hole and/or the change of the gasket are neither quick, nor simple to carry out.

The subject of the present invention is a new automatic door for molten metal holding furnaces, provided with double opening/closing and tilting mechanism for the replacement of the gaskets and/or the maintenance of the door and the charging hole.

The new door for holding furnaces constituted as described above simplifies the opening and closing operations, ensures easy and precise maintenance of the door and/or the charging hole and also the easy change of the gasket of the door itself, and furthermore no special external equipment is required to open, close or tilt it.

The new automatic door comprises a fixed plate with charging and inspection hole integral with the furnace itself, a mobile closing panel with replaceable gasket, two rotary guides, two parallel lever systems that press the closing panel against the furnace mouth, two adjusting mechanisms, a hydraulic cylinder that provides for the sliding movement of the closing panel and two hydraulic cylinders operating the lever systems that press the closing panel.

The following is just an example among many of a practical embodiment of the new automatic door, whose description refers to the attached drawings, wherein:

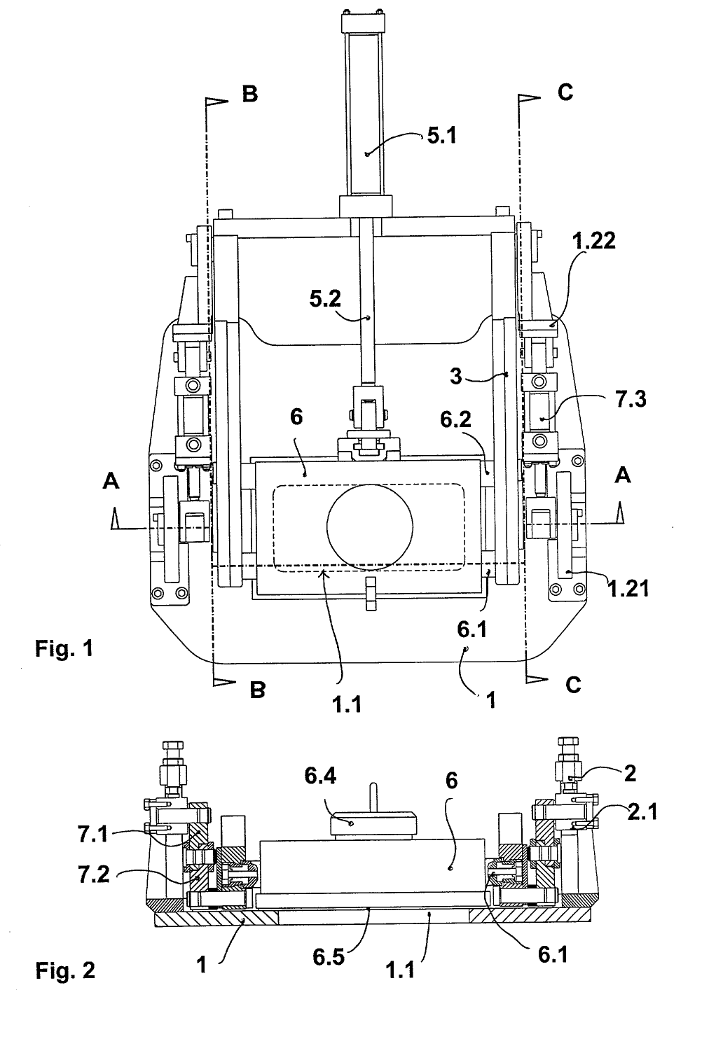

FIG. 1 is a front view of the new door, while

FIG. 2 shows an horizontal section (section A-A) and

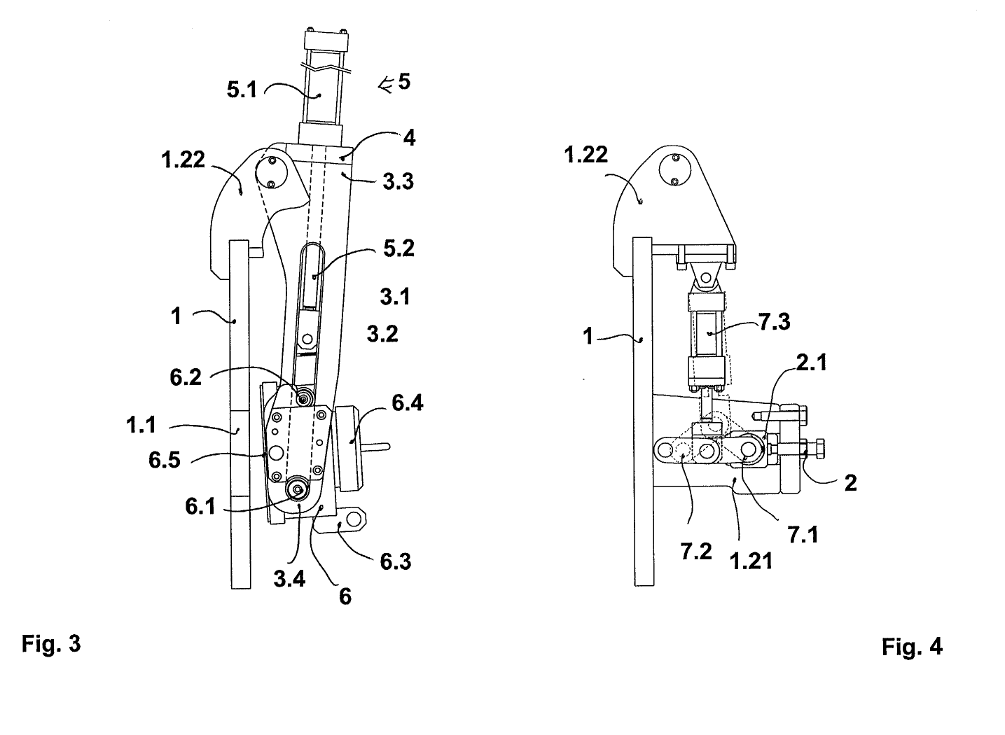

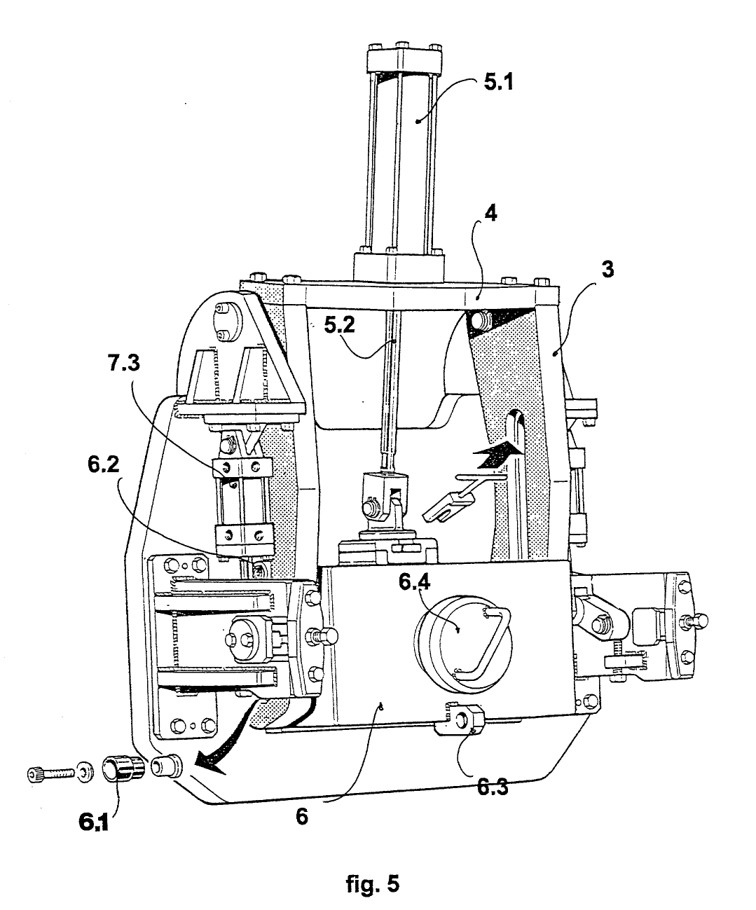

FIGS. 3-4 show two vertical sections of the same (section B-B, section C-C).

The plate (1) with charging hole (1.1) and structure (1.2) constitutes the mouth of the furnace; the hole (1.1) provided on the plate makes it possible to reach and/or inspect the inside of the furnace.

The structure (1.2) of said plate (1) serves as support and hinge for the other components of the new automatic door and in particular it comprises two supports (1.21) positioned at the sides of the charging hole (1.1) and two vertical wings (1.22) positioned on the upper part of the plate (1).

Each one of the two supports (1.21) positioned at the sides of the charging hole (1.1) is provided with one of the two adjusting mechanisms (2) that substantially comprise a drilled sliding element (2.1) that slides to approach and move away from the plate (1) with hole and can be locked as desired at intermediate distances from said plate (1).

Each one of the two rotary guides (3) is constituted by a generically rectangular plate (3.1) provided with a rectangular hole (3.2) parallel to the substantially vertical side of the plate (3.1) itself.

Each guide (3) has the upper end (3.3) hinged to a vertical wing (1.22) of the plate (1) with hole and is longer than the distance between said wings (1.22) and the lower edge of the charging hole (1.1) of said plate (1).

The upper ends (3.3) of the two guides (3) are joined by a cross element (4) that serves as fastening base for the hydraulic cylinder (5) that ensures the sliding movement of the closing panel (6).

The lower ends (3.4) of the two guides (3) are connected to the two lateral supports (1.21) of the plate (1) with hole by means of the pressure lever systems (7).

Each pressure lever system (7) comprises two connecting rods (7.1, 7.2) hinged to each other; one of said connecting rods (7.1), which is further from the plate (1) with hole, is hinged to the adjusting mechanism (2) described above, while the other connecting rod (7.2), which is nearer to the plate (1) with hole, is hinged to the lower end (3.4) of the adjacent rotary guide (3).

The two hydraulic cylinders (7.3) that make the door press against the hole (1) are connected to the upper vertical wings (1.22) of the plate (1) with hole and to the common hinge point (7c) between the two connecting rods (7.1, 7.2) of the pressurelever system (7).

Each retraction of the two hydraulic cylinders (7.3) causes a rotating movement of the two connecting rods (7.1, 7.2) that form an acute angle, moving the lower end (3.4) of the rotary guides (3) away from the plate (1) with hole; each extension of the two hydraulic cylinders (7.3) causes a rotating movement of the two connecting rods (7.1, 7.2) that form an obtuse or straight angle, reducing the distance between the lower end (3.4) of the rotary guides (3) and the plate (1) with hole.

The closing panel (6) that constitutes the actual opening and closing door comprises a panel made of a suitable material with appropriate thickness, provided on two opposite sides with four pins (6.1, 6.2), two for the right side and two for the left side, which slide in the rectangular holes (3.2) of the rotary guides (3).

In particular, the two upper pins (6.2) are fixed, while the two lower pins (6.1) can be removed from the closing panel (6).

The surface of the closing panel (6) that faces the plate (1) is equipped with an appropriate gasket (6.5).

A coupling point, a ring or a drilled plate (6.3) is provided near the lower edge of the closing panel (6).

The closing panel (6) can be provided with a hole with plug (6.4), in such a way as to permit a visual check of the inside of the furnace, with no need to open it.

The hydraulic cylinder (5) is applied to the cross element (4) that joins the upper ends (3.3) of the rotary guides (3) and is parallel to said rotary guides (3). In particular, the body (5.1) of the cylinder (5) is positioned on the side of the cross element (4) that is opposite the rotary guides (3), while the sliding rod (5.2) of the cylinder (5) is positioned between the rotary guides (3), connected to the upper edge of the closing panel (6).

The connection between the sliding rod (5.2) of the cylinder (5) and the closing panel (6) is such as to ensure a rapid release of said cylinder (5) from said closing panel (6), with a perpendicular movement with respect to the plane of the closing panel (6).

The movement of the rod (5.2) of the hydraulic cylinder (5) causes the translation of the closing panel (6) from a lower position in which it covers the hole (1.1) of the plate (1) completely to a higher position in which it leaves the hole (1.1) of the plate (1) completely free.

All the hydraulic cylinders (7.3, 5) of the new automatic door are controlled by appropriate solenoid valves that properly convey the flow of the pressurized fluid coming from an appropriate pump. An electronic/electromechanical unit controls the operation of the solenoid valves, the pump and the various operating and safety sensors during the opening, closing and servicing of the new automatic door.

When the door must be opened, the cylinders (7.3) are retracted, so that the lower ends (3.4) of the rotary guides (3) move away from the plate (1) with hole and successively the cylinder (5) is also retracted to move the closing panel (6) upwards and permit free access to the hole (1.1) of the plate (1) that constitutes the access to the furnace.

When the door must be closed the cylinder (5) is extended to move the closing panel (6) downwards until it is positioned before the hole (1.1) of the plate (1) and successively the cylinders (7.3) are extended, so that the lower ends (3.4) of the rotary guides (3) approach the plate (1) with hole, pressing the closing panel (6) and the relevant gasket (6.5) against the hole (1.1) of the plate (1) and thus closing the furnace.

Due to the successive pressure exerted by the closing panel (6) against the hole (1.1) of the plate (1), the thickness of the gasket (6.5) of the closing panel (6) is gradually reduced and it becomes necessary to act on the adjusting mechanisms (2) positioned on the lateral supports (1.21) of the plate (1) with charging hole (1).

When it is necessary to carry out maintenance operations on the closing panel (6), for example to replace the gasket (6.5) when it is worn, the closing panel (6) is moved away from the hole (1.1) of the plate (1) by retracting the cylinders (7.3), the rod (5.2) of the cylinder (5) is released from the closing panel (6) and the lower pins (6.1) of the closing panel (6) are removed (FIG. 5).

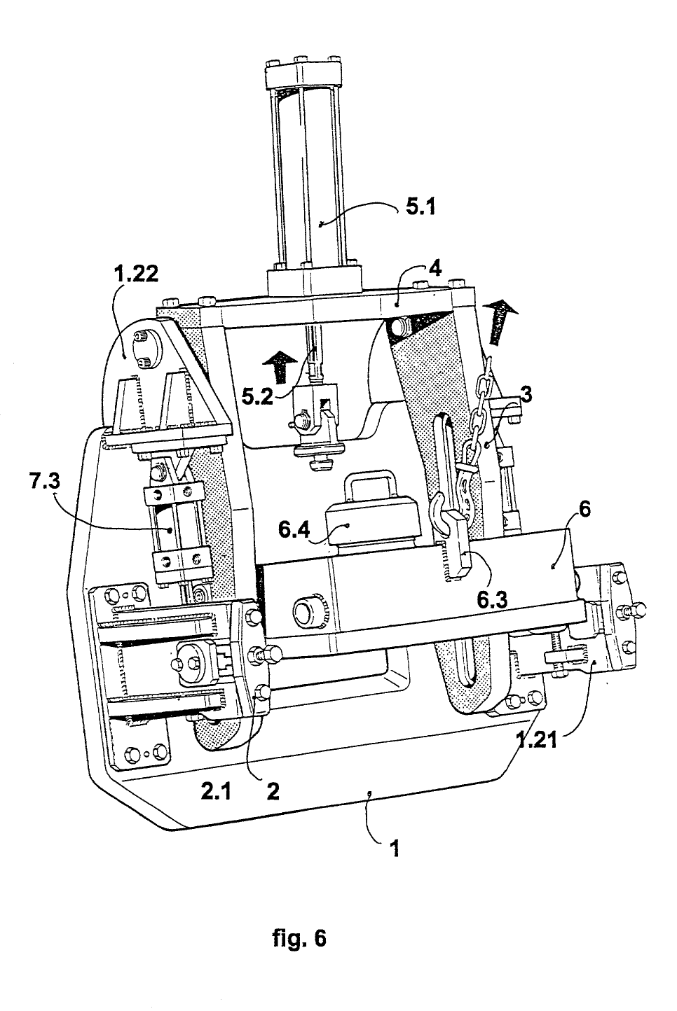

Successively, a winch or bridge crane is coupled to the coupling point, ring or drilled plate (6.3) provided near the lower edge of the closing panel (6) and the winch or bridge crane is operated, rotating the closing panel (6) completely, in such a way as to make its inner surface, which is generally pressed against the charging hole (1.1) fully visible (FIG. 6). To prevent the heat still present in the furnace from being dispersed and/or any object from falling inside the furnace, it is advisable to position a temporary wall or door on the charging hole of the furnace.

In order to prevent the fluid circulating in the hydraulic cylinder (5) and in the cylinders (7.3) from overheating due to the high temperature present immediately outside the furnace, the hydraulic circuits that operate said cylinder (5) and cylinders (7.3) are provided with double connections for the recirculation of the operating fluid, which is kept under pressure and conveyed in such a way as to make it pass through a suitable cooler.

In this way, by keeping the fluid temperature within the prescribed limits, it is possible to avoid the boiling of the fluid itself and any pressure variation of the same, which would make the operation of said cylinder (5) and cylinders (7.3) imprecise or even impossible.

These are sufficient indications to enable an expert person to realise the invention, consequently, in the final application, variations may be made without prejudicing the substance of the innovative concept.

Therefore, with reference to the above description and the enclosed drawings, the following claims are put forth.

1. Automatic door for molten metal holding furnace, characterized in that it comprises a fixed plate with charging and inspection hole, provided with two supports positioned at the sides of the charging hole and with two vertical wings positioned on the upper part of the plate, and wherein two guides with rectangular hole are hinged to the two vertical wings positioned on the upper part of the plate and directed downwards, beyond the lower edge of the charging hole, and wherein the closing panel with gasket is equipped with lateral pins that in turn are housed in the rectangular holes of the guides, said pins and guides being suitable for making the closing panel slide along the guides.

2. Automatic door for molten metal holding furnace according to claim 1, characterized in that it is provided with one or more pressuremechanisms acting on the lower end of the guides and rotating said guides in such a way as to bring the closing panel in contact with the plate hole and press the panel against the hole or to move it away from the plate.

3. Automatic door for molten metal holding furnace according to claim 1, 2, characterized in that each pressuremechanism is constituted by two connecting rods hinged to each other, wherein the connecting rod that is further from the plate is hinged to the support positioned beside the charging hole, while the connecting rod that is nearer to the plate is hinged to the lower end of the adjacent guide, and wherein a hydraulic cylinder connected to the upper wings of the plate and to the common hinge point between the two connecting rods provides for bending the connecting rods, so that each retraction of the cylinder causes a rotating movement of the two connecting rods that form an acute angle, moving the lower end of the guides away from the plate with hole and each extension of the cylinder causes a rotating movement of the two connecting rods that form an obtuse or straight angle, reducing the distance between the lower end of the guides and the plate with hole.

4. Automatic door for molten metal holding furnace according to claim 1, 2, 3, characterized in that it is provided with a hydraulic cylinder that controls the translation of the closing panel along the guides with rectangular hole.

5. Automatic door for molten metal holding furnace according to claim 1, 2, 3, 4, characterized in that the cylinder that controls the translation of the closing panel and the cylinders that operate the pressuremechanism are provided with double connections, and wherein the fluid that operates said cylinders is kept under pressure and in constant recirculation even by means of a radiator or cooler.
